(19) United States
(12) Patent Application Publication
(10) Pub. No.: US 2011/0227728 A1
(43) Pub. Date: Sep. 22, 2011

(54) Deterrent Alarm System

(76) Inventor: Derrick Mathis, Sharon Hill, PA (US)

(21) Appl. No.: 12/852,479

(22) Filed: Aug. 7, 2010

Related U.S. Application Data
(60) Provisional application No. 61/315,933, filed on Mar. 20, 2010.

(51) Int. Cl. G08B 1/08

(52) U.S. Cl. 340/539.29

(57) ABSTRACT

The invention relates to a system and method of using a remotely electronically-activated visual, auditory, or transmitted signal to alert persons within close proximity to the visual signal of an emergency situation. In an embodiment of the method of this invention, a visual signal is placed in a location within a structure facing a public area outside of the structure. To operate this system, a person activates an activation mechanism, such as by pushing a button, on a remote transmitter. The remote transmitter then sends an electromagnetic signal, preferably a radio signal, to the receiving antenna of a wireless signal receiver. Upon receiving the electromagnetic signal, the receiving antenna activates a switch that sends electric power from a power source to the visual signal. The electric power activates a light source inside of the visual signal, which lights up a warning message. The visual signal may further comprise an auditory signal, or, by interfacing with a communications system, the visual system may comprise a transmitted signal that relays information about the emergency.

### CROSS-REFERENCE TO RELATED APPLICATIONS

This application is entitled to the benefit of Provisional Patent Application Ser. No. 61/315,933 filed Mar. 20, 2010.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

(1) Field of the Invention

This invention pertains to the field of electronic communications systems generally, and in particular to the field of visually perceptible indications of the occurrence of an electrical signal.

(2) Description of Related Art

Building fire alarm systems often incorporate electronically-activated visual and auditory signals to indicate an emergency situation. Such signals are commonly activated either by wall-mounted manual switches or are activated automatically by a smoke or heat sensor, and are often accompanied by a loud audio alarm signal. Building security systems may also incorporate such signals, activated when an occupant depresses a switch, or activated automatically by sound or motion sensors detecting an intruder.

Conventional building alarm or security systems are generally designed to communicate an emergency message to persons inside the building and often to automatically contact persons who are not in close proximity to the facility, such as persons at a central alarm-monitoring facility, or police officers or firemen at the nearest station. Because the emergency responders are at a distant location, there may be a considerable and variable period of time between alarm activation and their arrival at the building. Another limitation of such systems is that they rely on a functioning communications network to alert distant responders. Such communication systems can break down due to a malfunction or blackout.

Building alarm systems also do not communicate their warning signal to pedestrians and other persons passing outside and within visual range of the building containing the alarm system. If the building is a store or bank being robbed, persons outside the building may not realize there is an emergency situation within, and may enter the building and be exposed to the dangerous situation. Because they are not alerted by a signal, persons outside and in close proximity to the building may not see or remember the exiting robbers.

Elderly and disabled people often use another type of alert system. Such alert systems are personal communications devices that the person carries on them and that they can activate if they are suffering a heart attack, a fall, or other emergency condition. Such systems generally contact a distant monitoring station, and people at this station then alert medical personnel or other emergency responders. These systems also suffer from the same problems of reliance on a functioning communications network, a variable and possibly extended response time by distant persons, and also fail to alert nearby pedestrians and neighbors that an emergency situation exists within the elderly person's home.

Car alarm systems also employ electronically-activated visual and auditory signals. Such signals are generally activated automatically in response to an unauthorized intrusion, and the alarm sound and blinking lights is meant to deter thieves. These systems are often set off accidentally, and consequently are usually set to turn off automatically after several minutes. These systems also generally cannot be activated automatically if the keys are in the ignition and the vehicle is running, and cannot be activated remotely unless the driver has the keys on his person. These alarms are usually accompanied by painfully loud noise, so nearby persons, like any potential thieves, tend to move away from the noise. Car alarm systems generally do not communicate any message to nearby persons.

Visual and auditory alert signals are also commonly used by emergency vehicles, such as fire trucks, police cars, and ambulances. Such signals are electronically activated by the drivers or occupants by depressing a switch inside the vehicle, and are meant to signal nearby motorists to move out of the emergency vehicle's path, or to pull off of the road. Aside from this commonly understood traffic control meaning, the sounds and visual signal do not communicate any message to nearby persons.

### BRIEF SUMMARY OF THE INVENTION

The invention relates to a system and method of using a remotely electronically-activated visual and auditory signal to alert persons within close proximity to the signal of an emergency situation.

### BRIEF DESCRIPTION OF THE DRAWING

FIG. 1 is a schematic view of an embodiment of the electronically activated visual signal communication system.

### DETAILED DESCRIPTION OF THE INVENTION

The invention addresses many of the shortcomings of the related art. Embodiments of the invention will allow users to communicate a warning to members of the public immediately and within proximity to the structure. The warning will empower the passing public, recruiting their assistance in contacting nearby emergency response personnel and in witnessing a crime in progress. The presence of the warning system should deter criminals. Neighbors will be able to respond rapidly to assist elderly people experiencing an emergency. Embodiments of the invention will have minimal response time and will not require a completely functioning communications system. This system and method may also increase efficient allocation of government resources, as it will enable police officers to easily scan a neighborhood for emergency situations requiring their assistance, merely by driving by locations where the system is implemented. Other embodiments of the system can be placed within a vehicle, such as a cab or delivery truck, and may be activated in an emergency to warn nearby persons or to recruit their assistance. The remote activation feature of the invention addresses shortcomings of hard-wired and manually activated systems in situations where it may be dangerous or impossible for a user to reach the button to turn on the alarm system.

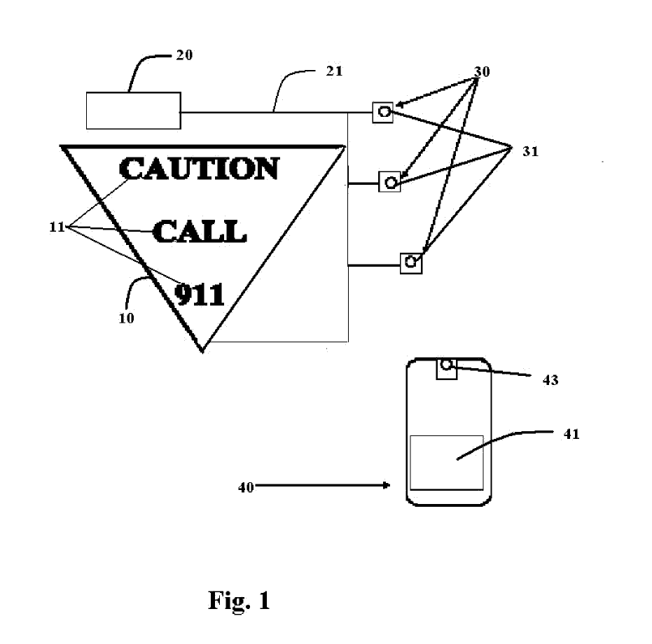

FIG. 1 depicts a schematic of an embodiment of the invention: a system comprising a visual signal 10 further comprising a warning message 11, a power source 20, wireless signal receivers 30 further comprising receiving antennas 31, electrically conductive wires 21 electrically connecting the wireless signal receivers 30 to the power source 20 and the visual signal 10, and a remote transmitter 40 further comprising an activation mechanism 41 and a transmitting antenna 43. In the embodiment depicted, the warning message 11 comprises the words CAUTION CALL 911 and the activation means is a button capable of being depressed.

To operate this system, a person activates the activation mechanism 41, such as by pushing a button. The remote transmitter 40 then sends an electromagnetic signal, preferably a radio signal, to the receiving antenna 31 of the wireless signal receivers 30. Upon receiving the electromagnetic signal, the receiving antennas 31 activate a switch that sends electric power from the power source 20 to the visual signal 10. The electric power activates a light source inside of the visual signal 10, which lights up the warning message 11.

To facilitate operation of the system, the wireless signal receivers 30 are positioned in places around the structure, preferably with clear lines of sight to areas occupied by people carrying remote transmitters 40. The visual signal 10 should preferably be positioned such that the warning message 11 faces the outside of the structure and is within view of any persons within visual range of the outside of the structure. The system can comprise more than one visual signal 10 placed in several locations. The system can be activated from more than one location by more than one remote transmitters 40 carried by structure occupants.

Preferably, once activated, the visual signal 10 cannot be deactivated remotely and must be disconnected from its power source 20. Alternately, the power source 20 may additionally comprise a deactivation system. The visual signal 10 may preferably be placed in a location where it cannot easily be deactivated.

The structure within which the system is installed preferably comprises a building, such as a residence, store, restaurant, or bank. The structure preferably has at least one outer surface facing toward an area of frequent foot traffic, such as a street, or sidewalk, a park, or other public area. The structure may also comprise a room or smaller area within a building. The structure may also comprise a vehicle, such as a truck or car. Preferably the vehicle is a cab or delivery vehicle.

The remote transmitters 40 should be light and small enough to be carried by a single person. The remote transmitters 40 can be made of any suitably sturdy material, preferably plastic or metal. The remote transmitters 40 should preferably be able to communicate with the wireless receivers 30 from distances of 0 to 50 feet, preferably at least 25 feet. The remote transmitters 40 should further comprise a portable power source, such as a battery. Preferably, the battery is rechargeable. The components of the remote transmitter 40 may be integrally connected to an electronic communications device with broader functions, such as a cell phone, or remote control for a security system, gate, or vehicle. The remote transmitter 40 may also be incorporated into jewelry, preferably a wrist band or watch, or a necklace. The activation mechanism 41 may be any suitable mechanism, including a button or a toggled switch. The activation mechanism 41 may also comprise a circuit activated by being broken.

The warning message 11 is preferably an easily visible color such as red or orange and preferably the warning message 11 becomes clearly visible only when the light source inside the visual signal 10 is activated. The warning message 11 should preferably comprise words that will caution people near the outside of the structure and warn them of an emergency situation within. The warning message should also preferably direct any persons within visual range to get help in the area and to call 911. The warning message may also comprise an auditory signal, activated by the same mechanism as the visual signal 10.

The system preferably further comprises a means of alerting all carriers of the remote transmitters 40 when someone has activated the visual signal 10. This means of alerting carriers is preferably a vibration mechanism within the remote transmitter 40 electrically connected to a receiving antenna and capable of receiving an electromagnetic signal from a transmitting antenna inside of the visual signal 10 or the wireless signal receivers 30. This will provide a means of notifying all carriers that someone has activated the visual signal system, and can also reassure victims that help is on the way.

The shapes, sizes, and colors of the system components can be customized to the particular needs of the user. The type of light source, and the type of power source can be altered to fit the user's desires and needs.

In a basic embodiment of the system, not depicted, the visual signal comprises a substantially flat, smooth, and thin cover piece with a front surface and a rear surface, and a frame having sides and a rear portion, that extends perpendicularly away from the periphery of the cover piece forming a cavity between the cover piece and the frame. The frame is adapted to be contiguously attached to the front cover piece by a fastener such as a screw or glue. The frame and cover piece may be constructed from a suitably sturdy material such as metal or hard plastic.

The cover piece further comprises a series of discrete openings forming the warning message “CAUTION CALL 911.” The warning message may comprise other phrases that alert, warn, or ask persons to get assistance, including but not limited to the words “GET HELP,” “EMERGENCY,” or “ROBBERY IN PROGRESS.” A flat and substantially transparent sheet is attached to the rear surface of the cover piece. The sheet is preferably made of a plastic material and is colored red. The cavity further comprises a light source positioned to the rear of the red plastic sheet, such that, when lit, it will illuminate the red lettering. The light source may be continuous or flashing. The warning message may also be formed by letters made of neon tubing. In this embodiment, the warning message could also be the light source.

The visual signal may further comprise a sound-producing device. This device is preferably a small horn, is activated at the same time as the light source, and the sound is preferably a continuous or alternating beeping noise.

The power source for the system may comprise a hard-wired connection to the structure's electric system. Alternatively, or additionally as a backup, the power source may comprise solar panels or batteries. In a vehicle the power source may comprise a power cord adapted to fit into the car cigarette charger. The presence of the system and its renown with the general public will deter potential crimes to occur.

The system may interface with other existing security, alarm, or alert systems, with the phone system, or with a device connected to the internet. The visual signal may further comprise a transmitted signal alerting emergency responders. The visual signal may further comprise additional information such as the user's name, number, or address. The visual signal may interface with a device that facilitates the sending of the visual signal over the internet to a social networking or messaging system. The visual signal may further comprise an auditory signal giving responders more information about the user's identity or the nature of the emergency.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalent.

The specification of the Provisional Patent Application Ser. No. 61/315,933 filed Mar. 20, 2010 is hereby incorporated by reference.

I claim:

1. A deterrent alarm system comprising a remote transmitter and a visual signal attached to the periphery of a structure,
a. the visual signal comprising a warning message, a power source, and a wireless signal receiver electronically connected to the warning message and the power source,
i. the wireless signal receiver being operative to sense pre-selected variations of electromagnetic radiation and upon sensing said radiation being effective to actuate the production of the warning message,
ii. the warning message being operative upon production to alert persons outside of the structure and within direct perceptive range of the visual signal,
b. the remote transmitter comprising a housing containing an activation mechanism, a transmitting antenna, and a portable power source,
i. the housing being of a size large enough to contain the activation mechanism, the transmitting antenna, and the portable power source and of a size small enough to be held in a person's hand,
ii. the activation mechanism being operative to energize the transmitting antenna,
iii. the transmitting antenna being operative to transmit pre-selected variations of electromagnetic radiation.

2. The invention of claim 1, wherein said structure comprises a building.

3. The invention of claim 1, wherein said structure comprises an automobile.

4. The invention of claim 1, wherein said visual signal is installed in a window.

5. The invention of claim 1, wherein said wireless signal receiver is also effective upon sensing pre-selected variations of electromagnetic radiation to actuate the cessation of the warning message.

6. The invention of claim 1, wherein production of the warning message continues until stopped by disconnecting the power source.

7. The invention of claim 1, wherein said pre-selected variations of electromagnetic radiation are radio waves.

8. The invention of claim 1, wherein said warning message is illuminated by a light source.

9. The invention of claim 1, wherein said warning message is red, orange, or yellow in color

10. The invention of claim 1, wherein said visible signal is visible to persons outside of the structure only when the visual signal is activated.

11. The invention of claim 1, wherein said warning message comprises a written message.

12. The invention of claim 1, wherein said warning message directs persons within visual range to summon assistance.

13. The invention of claim 1, wherein said warning message comprises an audible signal.

14. The invention of claim 1, wherein said remote transmitter further comprises an indicator that is operative to indicate when the visual signal has been activated.

15. The invention of claim 14, wherein the indicator is a vibration mechanism electrically connected to a receiving antenna and capable of receiving an electromagnetic signal, and wherein the visual signal further comprises a transmitting antenna operative to transmit an electromagnetic signal upon activation of the visual signal.

16. A deterrent alarm system comprising a remote transmitter and a visual signal attached to the periphery of a structure,
a. the visual signal comprising a warning message, a power source, and a wireless signal receiver electronically connected to the warning message and the power source,
i. the wireless signal receiver being operative to sense pre-selected variations of electromagnetic radiation and upon sensing said radiation being effective to actuate the production of the warning message,
ii. the warning message being operative upon production to alert persons outside of the structure and within direct perceptive range of the visual signal,
iii. the visual signal further comprising a substantially flat, smooth, and thin cover piece with a front surface and a rear surface, and a frame having sides and a rear portion, that extends perpendicularly away from the periphery of the cover piece forming a cavity between the cover piece and the frame,
b. the remote transmitter comprising a housing containing an activation mechanism, a transmitting antenna, and a portable power source,
i. the housing being of a size large enough to contain the activation mechanism, the transmitting antenna, and the portable power source and of a size small enough to be held in a person's hand,
ii. the activation mechanism being operative to energize the transmitting antenna,
iii. the transmitting antenna being operative to transmit pre-selected variations of electromagnetic radiation.

17. The invention of claim 16, wherein the warning message comprises translucent letters attached to the cover piece.

18. The invention of claim 16, wherein the warning message comprises neon tubes in the shape of letters.

19. The invention of claim 1, wherein the warning message is also transmitted to an electronic communications system.

20. The invention of claim 19, wherein the electronic communications system is the internet.
